(19) United States
(12) Patent Application Publication
(10) Pub. No.: US 2019/0248822 A1
(43) Pub. Date: Aug. 15, 2019

(54) METHOD FOR PREPARING A CATALYTIC SYSTEM COMPRISING A RARE-EARTH METALLOCENE

(71) Applicant: COMPAGNIE GENERALE DES ETABLISSEMENTS MICHELIN, Clermont-Ferrand (FR)

(72) Inventors: François JEAN-BAPTISTE-DIT-DOMINIQUE, Clermont-Ferrand Cedex 9 (FR); Vincent LAFAQUIERE, Clermont-Ferrand Cedex 9 (FR); Julien THUILLIEZ, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/320,463

(22) PCT Filed: Jul. 24, 2017
(86) PCT No.: PCT/FR2017/052041

§ 371 Date: Jan. 24, 2019

(30) Foreign Application Priority Data
Jul. 25, 2016 (FR) 16/57103

(51) Int. Cl. C07F 17/00; C08F 4/54; B01J 31/22; C08F 210/02; C08F 236/06; B01J 31/12

(52) U.S. Cl. CPC C07F 17/00; C08F 4/545; B01J 31/2295; B01J 2531/90; C08F 236/06; B01J 31/122; B01J 2531/38; C08F 210/02

(57) ABSTRACT

A one-pot process for preparing a preformed catalytic system based on a rare-earth metallocene in a hydrocarbon solvent in three performed steps.

This application is a 371 national phase entry of PCT/FR2017/052041 filed on 24 Jul. 2017, which claims benefit of French Patent Application No. 16/57103, filed 25 Jul. 2016, the entire contents of which are incorporated herein by reference for all purposes.

### BACKGROUND

### 1. Technical Field

The present invention relates to a process for preparing a catalytic system based on a rare-earth metallocene, in particular which can be used in the polymerization of monomers such as olefins, in particular conjugated dienes and ethylene.

### 2. Related Art

Catalytic systems based on rare-earth metallocenes are known: they are for example described in patent applications EP 1 092 731, WO 2004035639 and WO 2007054224 in the name of the applicant companies. They comprise a rare-earth metallocene and a cocatalyst, also referred to as an alkylating agent, which is generally an organometallic compound such as an organomagnesium, organoaluminium or organo lithium compound. There are prepared in a hydrocarbon solvent by an activation reaction of the metallocene by the cocatalyst. This activation reaction enables the formation of metal sites that are active with respect to the polymerization reaction of the abovementioned monomers. The active metal sites must remain during the polymerization both to maintain the catalytic activity and to guarantee the specificities of the polymerization product throughout the polymerization.

The metallocenes used in the known processes for preparing catalytic systems are organometallic complexes having at least one π ligand of cyclopentadienyl or similar type. They are conventionally prepared by reacting a salt of a ligand with a rare-earth metal salt, generally in polar solvents such as an ether. Before the use thereof in the known processes for preparing catalytic systems, they must be isolated from the reaction medium in which they were prepared and must also be purified to prevent the presence of impurities from interfering in the formation and stability of the active species responsible for the polymerization and from being found in the polymerization medium. The purification of metallocenes for the purposes of preparing the aforementioned catalytic systems therefore goes through at least one separation of the metallocenes from the reaction medium in which they were synthesized. The separation and purification are accomplished for example by operations of filtration, washing, solvent evaporation, recrystallization and drying of the metallocenes. These operations are long, tricky for some of them and generate numerous effluents to be treated in particular when it is a question of synthesizing large amounts of metallocenes. Finally, they have the result of making the process for preparing catalytic systems more complex. Furthermore, it is observed that the metallocenes, once isolated from the reaction medium and once purified, are sparingly soluble or are insoluble in that the hydrocarbon solvents used in the processes for polymerizing dienes, α-olefins or ethylene. This low solubility or this lack of solubility itself also complicates the preparation of the catalytic systems in these hydrocarbon solvents and the use thereof in polymerization. Consequently, there is an interest in finding a process for preparing the catalytic system that makes it possible to eliminate these steps that consist in isolating and purifying the metallocene.

### SUMMARY

The Applicant Companies, continuing their efforts, have discovered a process for preparing the catalytic system that makes it possible to eliminate these steps and provides a catalytic system that is active with respect to the polymerization of olefins, such as conjugated dienes and ethylene.

Thus, the invention relates to a process for preparing a catalytic system, which catalytic system is based at least:
on a preforming monomer selected from the group consisting of conjugated dienes, ethylene and a mixture thereof,
on a metallocene of formula (I) or of formula (II),

{P(Cp*)₂Y} (I)

(Cp*)₂Y (II)
Y denoting a group comprising a metal atom which is a rare earth metal,
Cp*, which are identical or different, being selected from the group consisting of fluorenyl groups, cyclopentadienyl groups and indenyl groups, the groups being substituted or unsubstituted,
P being a group that bridges the two Cp* groups, and that comprises a silicon or carbon atom,
on an organometallic compound as cocatalyst,
   which process comprises the following reactions a), b) and c):
a) synthesizing the metallocene in a hydrocarbon solvent from a salt of the rare-earth metal and a proligand, compound of formula (Ia) or (IIa), in the presence of a base

P^{a}(Cp^{1a})(Cp^{2a}) (Ia)

Cp^{3a} (IIa)
Cp^{1a} and Cp^{2a}, which are identical or different, being selected from the group consisting of fluorenyl groups, cyclopentadienyl groups and indenyl groups, the groups being substituted or unsubstituted,
Cp^{3a} being selected from the group consisting of fluorene, substituted fluorenes, cyclopentadiene, substituted cyclopentadienes, indene and substituted indenes,
P^{a} being a bridge connecting Cp^{1a} and Cp^{2a}, and comprising a silicon or carbon atom,
b) reacting the cocatalyst with the metallocene in the reaction medium resulting from reaction a),
c) reacting the preforming monomer with the product of the reaction b) in the reaction medium resulting from reaction b).

### DETAILED DESCRIPTION OF EXAMPLE EMBODIMENTS

In the present description, any interval of values denoted by the expression “between a and b” represents the range of values greater than “a” and lower than “b” (that is to say, limits a and b excluded), whereas any interval of values denoted by the expression “from a to b” means the range of values extending from “a” up to “b” (that is to say, including the strict limits a and b).

The expression “based on” used to define the constituents of the catalytic system is understood to mean the mixture of these constituents, or the product of the reaction of a portion or of all of these constituents with one another.

In the present application, metallocene is understood to mean an organometallic complex, the metal of which, in the case in point the rare-earth metal atom, is bonded to two Cp* groups or to a ligand molecule consisting of two Cp* groups connected together by a bridge P. The Cp* groups, which are identical or different, are selected from the group consisting of fluorenyl groups, cyclopentadienyl groups and indenyl groups, it being possible for these groups to be substituted or unsubstituted. It should be remembered that rare-earth elements are metals and denote the elements scandium, yttrium and the lanthanides, the atomic number of which ranges from 57 to 71.

In the present application, a proligand is understood to mean a compound that is intended to be transformed into a ligand of the metallocene.

The process in accordance with the invention relates to the preparation of a catalytic system in a hydrocarbon solvent. It should be understood by this formulation that the solvent, in which the catalytic system is, is a hydrocarbon solvent.

The process in accordance with the invention that has the essential feature of comprising the reaction a). The reaction a) makes it possible to prepare the metallocene of formula (I) or (II) which is an essential element on which the catalytic system is based.

{P(Cp*)₂Y} (I)

(Cp*)₂Y (II)
Y denoting a group comprising a metal atom which is a rare earth metal,
Cp*, which are identical or different, being selected from the group consisting of fluorenyl groups, cyclopentadienyl groups and indenyl groups, the groups being substituted or unsubstituted,
P being a group that bridges the two Cp* groups, and that comprises a silicon or carbon atom.

A key element of the reaction a) consists in preparing the metallocene directly in a hydrocarbon solvent that will serve as solvent for the catalytic system, which makes it possible to engage the metallocene in the subsequent reactions of the process without having to isolate it and purify it. The hydrocarbon solvent that will serve as solvent for the catalytic system is preferably a solvent containing from 5 to 12 carbon atoms. It may be aliphatic, preferably methylcyclohexane, or aromatic, preferably toluene. The hydrocarbon solvent is more preferentially methylcyclohexane or toluene.

The metallocene is conventionally prepared from a salt of the rare-earth metal and a proligand.

When the metallocene is of formula (I), the proligand is a compound of formula (Ia).

P^{a}(Cp^{1a})(Cp^{2a}) (Ia)
Cp^{1a} and Cp^{2a}, which are identical or different, being selected from the group consisting of fluorenyl groups, cyclopentadienyl groups and indenyl groups, the groups being substituted or unsubstituted,
P^{a} being a bridge connecting the 2 Cp^{1a} and Cp^{2a} groups, and comprising a silicon or carbon atom.

When the metallocene is of formula (II), the proligand is a compound of formula (IIa).

Cp³a (IIa)
Cp^{3a} being selected from the group consisting of fluorene, substituted fluorenes, cyclopentadiene, substituted cyclopentadienes, indene and substituted indenes.

The rare-earth metal salt may be a rare-earth metal halide, in particular a chloride, a rare-earth metal amide or a rare-earth metal borohydride, as described for example in patent applications EP 1 092 731, WO 2007054223 and WO 2007054224. Preferred as rare-earth metal salt are lanthanide halides, in particular chlorides, lanthanide amides, lanthanide borohydrides, and very particularly neodymium halides, in particular neodymium chloride, and neodymium borohydride. The salts may be in the form solvated by one or more molecules of an ether such as the salts NdCl₃(THF)₂, Nd(BH₄)₃(THF)₃ or non-solvated form such as the salt NdCl₃.

As regards the compounds of formula (Ia), the substituted cyclopentadienyl, fluorenyl and indenyl groups are for example substituted by alkyl radicals having from 1 to 6 carbon atoms or by aryl radicals having from 6 to 12 carbon atoms or else by trialkylsilyl radicals, such as SiMe₃ radicals. The choice of the radicals is also guided by the accessibility to the corresponding molecules, which are the substituted cyclopentadienes, fluorenes and indenes, because the latter are commercially available or can be easily synthesized.

Mention may in particular be made, as substituted fluorenyl groups, of 2,7-di(tert-butyl)fluorenyl and 3,6-di(tert-butyl)fluorenyl. The 2, 3, 6 and 7 positions respectively denote the positions of the carbon atoms of the rings as represented in the diagram below, the 9 position corresponding to the carbon atom to which the bridge P^{a} is attached.

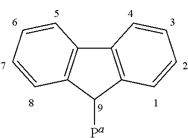

Mention may in particular be made, as substituted cyclopentadienyl groups, of those substituted in the 2 position, more particularly the tetramethylcyclopentadienyl group. Position 2 (or 5) denotes the position of the carbon atom which is adjacent to the carbon atom to which the bridge P^{a} is attached, as is represented in the diagram below.

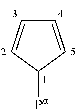

Mention may in particular be made, as substituted indenyl groups, of those substituted in the 2 position, more particularly 2-methylindenyl or 2-phenylindenyl. Position 2 denotes the position of the carbon atom which is adjacent to the carbon atom to which the bridge P^{a} is attached, as is represented in the diagram below.

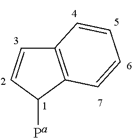

As regards the compounds of formula (IIa), the substituents of the cyclopentadiene, fluorene or indene are for example alkyl radicals having from 1 to 6 carbon atoms, aryl radicals having from 6 to 12 carbon atoms or else trialkylsilyl radicals, such as SiMe₃ radicals.

Mention may in particular be made, as substituted fluorenes, of 2,7-di(tert-butyl)fluorene and 3,6-di(tert-butyl)fluorene. The 2, 3, 6 and 7 positions respectively denote the positions of the carbon atoms of the rings as represented in the diagram below.

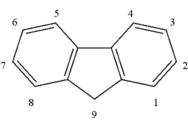 [SMILES: c1ccc2c(c1)Cc1ccccc1-2]

Mention may in particular be made, as substituted cyclopentadienes, of those substituted in the 2 position, more particularly the tetramethylcyclopentadiene group.

Mention may in particular be made, as substituted indenes, of those substituted in the 2 position, more particularly 2-methylindene or 2-phenylindene. The 2 position denotes the position of the carbon atom as represented in the diagram below.

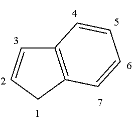

The synthesis of the metallocene from the rare-earth metal salt and the proligand is carried out in 2 steps. The first step is a deprotonation reaction of the proligand in the presence of a base in order to form a salt of the proligand, the second step consists in reacting the salt of the proligand with the rare-earth metal salt.

In the first step, the proligand is typically reacted with the base in a stoichiometry that corresponds to between 1 and 1.5 mol of base per mole of acid proton of the proligand. The acid proton is the proton present on the ring containing 5 carbon atoms that constitutes the Cp^{1a}, Cp^{2a} and Cp^{3a} groups. The stoichiometry is typically between 1 and 1.5 mol of base per mole of proligand of formula (IIa) and between 2 and 3, preferentially between 2 and 2.2 mol of base per mole of proligand of formula (Ia). The first step is carried out under an inert atmosphere, for example under nitrogen or argon, under anhydrous conditions and conventionally occurs in two phases with stirring in a reactor. The first phase corresponds to the addition of the base to the proligand at a temperature ranging typically from −80 to 60° C., preferably from −20° C. to 60° C., more preferentially from 0 to 30° C. The second phase amounts to continuing to stir the reaction medium resulting from the first phase generally under the following conditions: at a temperature of from −20 to 60° C. for from 10 minutes to 24 hours, then at a temperature of from 20 to 90° C., in particular from 20 to 70° C. The first step is generally carried out in the presence of a solvent. At the end of the first step a salt of the ligand is prepared which serves as deprotonated form of the proligand. The salt of the ligand constitutes a reaction intermediate in the synthesis of the metallocene. This reaction intermediate may or may not be isolated from its reaction medium before being used in the second step of the synthesis of the metallocene. The operations for isolating and purifying a ligand salt are well known to a person skilled in the art in the synthesis of ligand salts, such as for example filtration, precipitation from a second solvent, washing, recrystallization, and may be used in the present case. Such operations are, for example, described in documents EP 1 092 731, WO 2007054223 and WO 2007054224.

The base used in the first step is typically a metal alkyl or an alkali metal amide. As metal alkyl, use may be made of an alkylmagnesium, an alkyllithium or an alkylaluminium. As alkali metal amide, use may be made of an alkali metal bis(trimethylsilyl)amide, an alkali metal diisopropylamide, such as lithium bis(trimethylsilyl)amide or lithium diisopropylamide. Preferably, the base is preferably an alkyllithium, more preferentially butyllithium, more preferentially still n-butyllithium.

The solvant used for the first step may be an ether, a hydrocarbon compound, or a mixture thereof. As ether, diethyl ether and tetrahydrofuran are preferred. As hydrocarbon compound, aliphatic or aromatic solvents are suitable, preferably the hydrocarbon solvent that will serve as solvent for the catalytic system.

The variant of the process that uses an ether as solvent of the first step necessitates isolating and purifying the salt of the ligand. According to this variant, the salt of the ligand is in the form of a powder. On the other hand, the variant of the process which uses a hydrocarbon compound as solvent of the first step does not necessitate either isolating or purifying the salt of the ligand, which represents a certain advantage over the other variant.

In the second step, the salt of the ligand is generally reacted with the rare-earth metal salt in a stoichiometry that corresponds to between 0.45 and 0.75 mol of rare-earth metal salt per mole of carbanion resulting from the first step. The stoichiometry is typically between 0.45 and 0.75, preferably between 0.45 and 0.55 mol of rare-earth metal salt per mole of ligand salt for a proligand of formula (IIa) and between 0.9 and 1.5, preferably between 0.95 and 1.1 of rare-earth metal salt per mole of ligand salt for a proligand of formula (Ia). The second step is also carried out under an inert atmosphere, for example under nitrogen or argon, under anhydrous conditions and conventionally occurs in two phases with stirring. The first phase corresponds to the addition of the rare-earth metal salt to the ligand salt at a temperature generally ranging from −20 to 90° C., preferably from 20 to 60° C. The second phase amounts to continuing to stir the reaction medium resulting from the first phase generally under the following conditions: for from 10 minutes to 24 hours at a temperature ranging from 20 to 90° C., in particular from 20 to 60° C. As a key step of the process in accordance with the invention for preparing the catalytic system is the use of the metallocene without having to isolate it from the reaction medium in which the metallocene was synthesized, the second step for preparing the metallocene is carried out in the hydrocarbon solvent which will serve as solvent of the catalytic system. When the salt of the ligand and the salt of the rare-earth metal are used in the form of a solution or a suspension in a solvent in order to be introduced into the reactor, this solvent is an aliphatic or aromatic hydrocarbon solvent. It may be different from the hydrocarbon solvent that will serve as solvent of the catalytic system, since the volume amount of this solvent added during the introduction of these reactants will be in the minority in the catalytic system relative to the total volume of solvent.

According to one variant applicable to the synthesis of a metallocene, the Y symbol of which comprises a borohydride moiety, the salt of the ligand may react firstly with a rare-earth metal halide under the same conditions as the second step of the reaction a) described above, in particular the rare-earth metal chloride. The chlorinated complex is then formed as intermediate which reacts in turn with an alkali metal salt borohydride, such as sodium borohydride, added to the reaction medium once the chlorinated complex is formed. The displacement of the chlorine atom by the borohydride group in the metallocene is carried out under reaction conditions identical to those of the second step of the reaction a). This variant makes it possible for example to synthesize a metallocene of formula (I), in particular the metallocene of formula (IV) with the advantage of not first preparing the rare-earth metal salt Nd(BH₄)₃(THF)₃ which is not a commercial product.

Me₂Si(Flu)₂Nd(BH₄)_{1+y)}.THFₓ₋L_{y} (IV)
Flu representing the C₁₃H₈ group,
L represents an alkali metal selected from the group consisting of lithium, sodium and potassium,
x, which may or may not be an integer, is equal to or greater than 0,
y, which is an integer, is equal to or greater than 0.

At the end of the reaction a), i.e. once the metallocene has been synthesized, the metallocene is reacted with a cocatalyst in the reaction b) in order to activate the metallocene, knowing that the metallocene is still in the reaction medium resulting from the reaction a). In other words, the cocatalyst is added to the reaction medium resulting from the reaction a) and containing the metallocene obtained in the reaction a).

The reaction b) is an activation of the metallocene by the cocatalyst, also commonly referred to as alkylating agent. The reaction b) is also commonly referred to as alkylation. The cocatalyst is used according to a (cocatalyst/metal of the metallocene) molar ratio ranging preferably from 0.5 to 100, more preferentially from 1 to 100, more preferentially still from 1 to 10. In the reaction b), the metal concentration of the cocatalyst is preferably within a range extending from 0.00005 to 5 mol/l in the reaction medium, preferentially from 0.0005 to 3 mol/l. The reaction b) is also carried out under an inert atmosphere, for example under nitrogen or argon, under anhydrous conditions and conventionally occurs in two phases with stirring. The first phase corresponds to the addition of the cocatalyst to the metallocene at a temperature typically ranging from 20 to 80° C. The cocatalyst is generally added in the form of a solution in an aliphatic or aromatic hydrocarbon solvent, preferably an aliphatic hydrocarbon solvent such as hexane, heptane or methylcyclohexane, generally at a concentration ranging from 0.1 to 5 mol/l. The solvent used for introducing the cocatalyst into the reactor may be different from the hydrocarbon solvent that will serve as solvent of the catalytic system, since the volume amount of this solvent added during the introduction of the cocatalyst will be in the minority in the catalytic system relative to the total volume of solvent.

The second phase amounts to continuing to stir the reaction medium resulting from the first phase generally under the following conditions: at a temperature ranging from 20 to 80° C., in particular from 20 to 60° C., for from 1 minute to 24 hours, preferably from 1 minute to 1 hour, more preferentially between 10 and 20 min.

The cocatalyst is, in a well-known way, an organometallic compound. The organometallic compounds capable of activating the metallocene, such as organomagnesium, organoaluminium and organolithium compounds, may be suitable. The cocatalyst is preferably an organomagnesium compound, i.e. a compound which has at least one C—Mg bond. Mention may be made, as organomagnesium compounds, of diorganomagnesium compounds, in particular dialkylmagnesium compounds, and of organomagnesium halides, in particular alkylmagnesium halides. The diorganomagnesium compound has two C—Mg bonds, in the case in point C—Mg—C; the organomagnesium halide has one C—Mg bond. More preferably, the cocatalyst is a diorganomagnesium compound.

According to a particularly preferred embodiment of the invention, the cocatalyst is an organometallic compound comprising an alkyl group bonded to the metal atom. Alkylmagnesium compounds, very particularly dialkylmagnesium compounds, or alkylmagnesium halides, are particularly suitable as cocatalyst, also known as alkylating agent. The alkyl radical or the alkyl radicals in this particularly preferred embodiment typically comprise from 2 to 8 carbon atoms. The cocatalyst is more preferentially dibutylmagnesium, butyloctylmagnesium, butylethylmagnesium or butylmagnesium chloride. The cocatalyst is advantageously butyloctylmagnesium.

At the end of the reaction b), the reaction c) is carried out by reacting the preforming monomer with the product of the reaction b) which is still in its reaction medium resulting from the reaction b). The reaction b) is a preforming of the catalytic system. The preforming monomer is used according to a (preforming monomer/metal of the metallocene) molar ratio ranging preferably from 5 to 1000, more preferentially from 10 to 500. The reaction c) is also carried out under an inert atmosphere, for example under nitrogen or argon, under anhydrous conditions and occurs with stirring conventionally in two phases or three phases. The first phase corresponds to the addition of the preforming monomer to the product of the reaction b) at a temperature ranging generally from 20 to 90° C., preferably from 20 to 60° C. The second phase amounts to continuing to stir the reaction medium resulting from the first phase generally under the following conditions: at a temperature ranging from 40 to 120° C., in particular from 40 to 90° C., for from 0.5 hour to 48 hours, preferably from 1 hour to 25 hours. The second phase is, if need be, followed by a third phase in order to eliminate the preforming monomer which might not have reacted. The third phase is conventionally accomplished by a degassing operation of the reactor by purging with nitrogen at a temperature generally ranging from 20 to 80° C., which reactor contains the reaction medium.

The preforming monomer is selected from the group consisting of conjugated dienes, ethylene and a mixture thereof. When the preforming monomer is a mixture of ethylene and a conjugated diene, the molar fraction of ethylene in the preforming monomer may vary to a large extent, in particular within a range extending from 0.001 to less than 1. The conjugated diene is preferably a 1,3-diene such as 1,3-butadiene or isoprene.

According to one preferential embodiment of the invention, the preforming monomer is 1,3-butadiene or isoprene.

According to another preferential embodiment of the invention, the preforming monomer is a mixture of ethylene and 1,3-butadiene.

According to one particular embodiment of the invention, the metallocene is of formula (I). The Cp* groups of the metallocene of formula (I) are preferably identical and are selected from the group consisting of substituted fluorenyl groups and the unsubstituted fluorenyl group of formula C₁₃H₈. More preferentially, the Cp* groups of the metallocene of formula (I) each represent an unsubstituted fluorenyl group of formula C₁₃H₈. According to this embodiment, a person skilled in the art understands that the proligand is a compound of formula (Ia) in which the Cp* groups are preferably identical and are selected from the group consisting of substituted fluorenyl groups and the unsubstituted fluorenyl group of formula C₁₃H₈, more preferentially each represent an unsubstituted fluorenyl group of formula C₁₃H₈.

According to another particular embodiment of the invention, the symbol Y in the formula (I) or (II) represents a group Met-G, with the symbol Met denoting a metal atom which is a rare-earth metal and the symbol G denoting a group comprising the borohydride BH₄ moiety or denoting a halogen atom X selected from the group consisting of chlorine, fluorine, bromine and iodine. According to this embodiment, the rare-earth metal salt used in step a) is a rare-earth metal borohydride or a rare-earth metal halide.

In the variant according to which Y represents Met-G with G comprising a borohydride moiety, the symbol G preferably denotes a group of formula (III)

(BH₄)_{(1+y)-}L_{y}Nₓ (III)

in which:
L represents an alkali metal selected from the group consisting of lithium, sodium and potassium,
N represents a molecule of an ether, preferably tetrahydrofuran,
x, which may or may not be an integer, is equal to or greater than 0,
y, which is an integer, is equal to or greater than 0.

In the variant according to which Y represents Met-G with G being a halogen atom, the symbol G preferably denotes a chlorine atom, in which case the rare-earth metal salt used in the reaction a) is a rare-earth metal chloride.

According to any one of the embodiments of the invention, the rare-earth metal is preferably a lanthanide, the atomic number of which varies from 57 to 71, more preferentially neodymium (Nd), which means that the rare-earth metal salt used in the reaction a) is preferably a lanthanide salt, more preferentially a neodymium salt.

When the metallocene is of formula (I), the bridge P preferably corresponds to the formula ZR¹R², Z representing a silicon or carbon atom and R¹ and R², which are identical or different, each representing an alkyl group comprising from 1 to 20 carbon atoms, in particular a methyl. More preferentially, the bridge P is of formula Si R¹R². More preferentially still, the bridge P is of formula SiMe₂. These preferential embodiments define the structure of the proligand of formula (Ia) used in the reaction a) through the nature of the bridge P^{a} which is of the same chemical structure as the bridge P.

According to a very particularly preferred embodiment of the invention, the metallocene is a (dimethylsilyl)bisfluorenylneodymium borohydride of formula (IV)

Me₂Si(Flu)₂Nd(BH₄)_{(1+y)-}THFₓ-L_{y} (IV)
Flu representing the C₁₃H₈ group.
   L represents an alkali metal selected from the group consisting of lithium, sodium and potassium,
   x, which may or may not be an integer, is equal to or greater than 0,
   y, which is an integer, is equal to or greater than 0.

According to any one of the embodiments of the invention, the molar concentration of metal of the metallocene in the catalytic system preferably has a value ranging from 0.0001 to 0.08 mol/l, more preferentially from 0.001 to 0.05 mol/l.

The catalytic system prepared according to the process in accordance with the invention may then be used in the polymerization of a monomer M. If it is not used straightaway, it is stored under anhydrous conditions under an inert atmosphere, in particular under nitrogen, at a temperature ranging from −20° C. to ambient temperature (23° C.), for example in hermetically sealed bottles.

The monomer M is to be distinguished from the preforming monomer used in the preparation of the catalytic system in the reaction b): the monomer M may or may not be identical to the monomer used in the reaction b). The monomer M is selected from the group of monomers consisting of conjugated dienes, ethylene, α-monoolefins and mixtures thereof. As conjugated dienes, 1,3-dienes preferably having from 4 to 8 carbon atoms, in particular 1,3-butadiene and isoprene, are very particularly suitable.

According to the microstructure and the length of the polymer chains prepared by the process in accordance with the invention, the polymer may be an elastomer.

The polymerization is preferably carried out in solution, continuously or batchwise. The polymerization solvent may be an aromatic or aliphatic hydrocarbon solvent, preferably a solvent which is identical to the solvent of the catalytic system. Mention may be made, as example of polymerization solvent, of toluene and methylcyclohexane. The monomer M may be introduced into the reactor containing the polymerization solvent and the catalytic system or, conversely, the catalytic system may be introduced into the reactor containing the polymerization solvent and the monomer. The monomer and the catalytic system may be introduced simultaneously into the reactor containing the polymerization solvent, in particular in the case of a continuous polymerization. The polymerization is typically carried out under anhydrous conditions and in the absence of oxygen, in the optional presence of an inert gas. The polymerization temperature generally varies within a range extending from 40° C. to 120° C.

The polymerization can be halted by cooling the polymerization medium. The polymer can be recovered according to conventional techniques known to a person skilled in the art, such as, for example, by precipitation, by evaporation of the solvent under reduced pressure or by steam stripping.

The abovementioned characteristics of the present invention, and also others, will be better understood on reading the following description of several exemplary embodiments of the invention, given by way of illustration and without limitation.

### EXEMPLARY EMBODIMENTS OF THE INVENTION

### 1—Reagents and Solvents

The methylcyclohexane, toluene and butadiene were purified over an alumina guard.

The butyllithium comes from Aldrich (1.4 mol.l⁻¹) and was used without additional purification.

The butyloctylmagnesium in heptane (20% by weight) which is used as cocatalyst comes from Chemtura and was used without additional purification.

The adduct Nd(BH₄)₃THF₃ was prepared according to the protocol described in the article by S. M. Cendrowski-Guillaume, G. Le Gland, M. Nierlich, M. Ephritikhine, Organometallics 2000, 19, 5654-5660.

The adduct NdCl₃THF₂ was synthesized according to the method B described in “Synthetic Methods of Organometallic and Inorganic Chemistry”, Volume 6, 1997, published by W. A. Herrmann, Frank T. Edelmann.

The complex [Me₂SiFlu₂Nd(BH₄)₂Li(THF)]₂ was prepared according to the protocol described in patent application FR2893028.

The proligand Me₂SiFLu₂ was prepared according to the protocol described in patent application FR2893028.

### 2—Analyses

### 2-1—Nuclear Magnetic Resonance (NMR) Spectroscopy

The microstructure of the polymers was determined by ¹³C NMR analysis. The spectra are acquired on a Bruker 500 MHz spectrometer equipped with a 5 mm BBI Z-grad “broad band” probe. The quantitative ¹H NMR experiment uses a simple 30° pulse sequence and a repetition time of 3 seconds between each acquisition. The samples are dissolved in deuterated chloroform. The ¹³C NMR spectrum is calibrated with the carbon from the CDCl₃ at 77 ppm. The integrations carried out in order to calculate the microstructure are presented in Table 1 below.

TABLE 1

| | Chemical shifts | Number of C |
|---|---|---|
| Structure | ¹³C (ppm) | considered |
| CH═CH of 1,4-PB | 128-133 | 2 |
| ethylenic CH═CH of 1,2-PB | 112-115 | 1 |
| CH of the 6-membered ring moiety | 41-42 | 2 |
| C in the alpha position of the vinyl | 34.3-35.8 | 2 |
| function of 1,2-PB | | |
| CH2 of PE | 26.8-31.5 | 2 |

### 2-2—Differential Scanning Calorimetry (DSC)

The glass transition temperature (Tg) was determined by DSC on a Mettler Toledo DSC 822 B machine under a helium atmosphere and according to the following protocol:
sample brought from ambient temperature to +100° C.
rapid cooling to −150° C.
new temperature increase from −150° C. to +200° C., at 20° C./min.

### 3—Example in Accordance with the Invention: Example 1

The catalytic system is prepared according to the process in accordance with the invention. A 1.4 M solution of n-butyllithium in hexane (2.2 ml, 3.08 mmol) is added under an inert atmosphere of nitrogen and at ambient temperature to a solution of Me₂SiFLu₂ (0.545 g, 1.40 mmol) in toluene (50 ml). The solution is kept stirring at ambient temperature for 12 h, then is heated with stirring at 60° C. for 2 hours. After returning to ambient temperature, the adduct Nd(BH₄)₃THF₂ (0.570 g, 1. 40 mmol) is added under an inert atmosphere of nitrogen to the reaction mixture and the suspension is stirred for 12 hours at ambient temperature. Added to this suspension, under an inert atmosphere of nitrogen and at ambient temperature, are a 0.834M solution of butyloctylmagnesium (BOMAG) in heptane (3.72 ml, 3.10 mmol, 2.2 equivalents relative to the amount of neodymium), then 107 ml of toluene and finally butadiene (10.7 ml, 127.6 mmol, 90 equivalents relative to the amount of neodymium). The reaction mixture is stirred for 24 h at 60° C. At the end of this period, a brown solution of catalytic system is obtained with a final neodymium concentration of 0.00857 mol/l.

The catalytic system is then used in the copolymerization of ethylene and 1,3-butadiene according to the following procedure:

The catalytic system (5.47 ml), butyloctylmagnesium (BOMAG, 2.8 molar equivalents relative to the neodymium) and the monomers are added to a 500 ml reactor containing methylcyclohexane (300 ml), the 1,3-butadiene and ethylene monomers being introduced in the form of a gas mixture containing 20 mol % of 1,3-butadiene. The polymerization is carried out at 80° C. and at a constant pressure of 4 bar. The polymerization reaction is stopped by cooling and degassing of the reactor and the solvent is evaporated in order to recover the dry copolymer. The weight weighed makes it possible to determine the mean catalytic activity of the catalytic system, expressed in kilograms of copolymer synthesized per mole of catalytic system and per hour (kg/mol.h).

### 4—Examples Not in Accordance with the Invention

Examples 2 and 3 are not in accordance with the invention, in that the metallocene, once synthesized, is isolated from its reaction medium before being used in a catalytic system described according to the document WO 2007/054224.

### 4-1—Example 2

A 1.4 M solution of n-butyllithium in hexane (2.04 ml, 2.87 mmol) is, under an inert atmosphere of nitrogen, added at ambient temperature to a solution of Me₂SiFLu₂ (0.504 g, 1.29 mmol) in toluene (50 ml). The solution is kept stirring at ambient temperature for 12 h, then is heated with stirring at 60° C. for 2 hours. The product is then dried under vacuum in order to obtain an orangey yellow powder over 24 h. To a suspension of Me₂SiFLu₂Li₂ (0.520 g, 1.29 mmol) in 75 ml of ether, the adduct Nd(BH₄)₃THF₃ (0.525 g, 1.29 mmol) in suspension in ether (75 ml) is added under an inert atmosphere of nitrogen to the reaction mixture and the suspension is stirred for 12 hours at ambient temperature. The solvent is finally evaporated under vacuum over 24 h and the product obtained is a brown powder.

The metallocene (31.3 mg) and butyloctylmagnesium (BOMAG, 5 molar equivalents relative to the neodymium) are added to a 500 ml reactor containing methylcyclohexane (300 ml). The polymerization is carried out at 80° C. and at a constant pressure of 4 bar. The 1,3-butadiene and ethylene monomers are introduced in the form of a gas mixture containing 20 mol % of 1,3-butadiene. The polymerization reaction is stopped by cooling and degassing of the reactor and the solvent is evaporated in order to recover the dry copolymer. The weight weighed makes it possible to determine the mean catalytic activity of the catalytic system, expressed in kilograms of copolymer synthesized per mole of catalytic system and per hour (kg/mol.h).

### 4-2—Example 3

Example 3 differs from Example 2 in that in the synthesis of the metallocene of Example 3 the salt of the proligand Me₂SiFLu₂Li₂ resulting from the deprotonation of the ligand by the base is not isolated from its reaction medium before reacting with the rare-earth metal salt. It is noted that the synthesis of the metallocene is carried out under the same conditions as the synthesis of the metallocene of Example 1. Unlike Example 1, the metallocene of Example 2 is isolated from its reaction medium before being used in the preparation of the catalytic system.

A 1.4M solution of n-butyllithium in hexane (2.2 ml, 3.08 mmol) is added under an inert atmosphere of nitrogen and at ambient temperature to a solution of Me₂SiFLu₂ (0.545 g, 1.40 mmol) in toluene (50 ml). The solution is kept stirring at ambient temperature for 12 h, then is heated with stirring at 60° C. for 2 hours. After returning to ambient temperature, the adduct Nd(BH₄)₃(THF)₃ (0.570 g, 1.40 mmol) is added under an inert atmosphere of nitrogen to the reaction mixture and the suspension is stirred for 12 hours at ambient temperature. The solvent is finally evaporated under vacuum over 24 h and the product obtained is a brown powder (1.04 g).

The metallocene (33.5 mg) and butyloctylmagnesium (BOMAG, 5 molar equivalents relative to the neodymium) are added to a 500 ml reactor containing methylcyclohexane (300 ml). The polymerization is carried out at 80° C. and at a constant pressure of 4 bar. The 1,3-butadiene and ethylene monomers are introduced in the form of a gas mixture containing 20 mol % of 1,3-butadiene. The polymerization reaction is stopped by cooling and degassing of the reactor and the solvent is evaporated in order to recover the dry copolymer. The weight weighed makes it possible to determine the mean catalytic activity of the catalytic system, expressed in kilograms of copolymer synthesized per mole of catalytic system and per hour (kg/mol.h).

### 5—Results

The catalytic activities of the catalytic systems appear in Table 2: they are expressed in base 100, the value 100 being assigned to Example 2. A value of greater than 100 indicates an increase in the catalytic activity.

TABLE 2

| Example | 2 | 3 | 1 |
|---|---|---|---|
| Catalytic activity | 100 | 95 | 91 |

The microstructure and the glass transition temperature of the polymers obtained are given in Table 3. The proportion of ethylene units in the polymer is expressed as a molar percentage relative to all of the units forming the polymer. The proportions of units formed from the 1,3-butadiene monomer, namely of 1,4-moiety; of 1,2-moiety and of cyclic moiety are expressed as a molar percentage relative to all of the units formed from the 1,3-butadiene monomer in the polymer.

TABLE 3

| | Ethylene | 1,4- | 1,2- | cyclic | Tg |
|---|---|---|---|---|---|
| Example | (mol %) | (mol %) | (mol %) | (mol %) | (° C.) |
| 1 | 82 | 25 | 26 | 49 | −34 |
| 2 | 83 | 24 | 22 | 54 | −33 |
| 3 | 82 | 25 | 26 | 49 | −34 |

It is observed that the catalytic system prepared according to the process in accordance with the invention is effective in the polymerization, since it enables the synthesis of a polymer having the same microstructure as the polymers obtained in Examples 2 and 3. Even though a slight drop in catalytic activity is noted relative to Example 2, it proves to be a lesser drop if it is compared with the catalytic activity of Example 3. The comparison of Example 1 with Example 3 is very relevant, since the metallocene used in Examples 1 and 3 is prepared under the same conditions, i.e. without isolating the salt of the proligand, which is not the case for the metallocene of Example 2.

In summary, the process in accordance with the invention has the advantage of simplifying the preparation of catalytic systems, in particular by making it possible to use the metallocene in the reaction medium in which it was isolated.

1. A process for preparing a catalytic system, which catalytic system is based at least:
on a preforming monomer selected from the group consisting of conjugated dienes, ethylene and a mixture thereof,
on a metallocene of formula (I) or of formula (II),
on an organometallic compound as cocatalyst,
{P(Cp*)₂Y} (I)
(Cp*)₂Y (II)
Y denoting a group comprising a metal atom which is a rare earth metal,
Cp*, which are identical or different, being selected from the group consisting of fluorenyl groups, cyclopentadienyl groups and indenyl groups, the groups being substituted or unsubstituted,
P being a group that bridges the two Cp* groups, and that comprises a silicon or carbon atom,
which process comprises the following reactions a), b) and c):
a) synthesizing the metallocene in a hydrocarbon solvent from a salt of the rare-earth metal and a proligand, compound of formula (Ia) or (IIa), in the presence of a base
P^{a}(Cp^{1a})(Cp₂ₐ) (Ia)
Cp^{3a} (IIa)
Cp^{1a} and Cp^{2a}, which are identical or different, being selected from the group consisting of fluorenyl groups, cyclopentadienyl groups and indenyl groups, the groups being substituted or unsubstituted,
Cp^{3a} being selected from the group consisting of fluorene, substituted fluorenes, cyclopentadiene, substituted cyclopentadienes, indene and substituted indenes,
P^{a} being a bridge connecting Cp^{1a} and Cp^{2a}, and comprising a silicon or carbon atom,
b) reacting the cocatalyst with the metallocene in the reaction medium resulting from reaction a),
c) reacting the preforming monomer with the product of the reaction b) in the reaction medium resulting from reaction b).

2. A process according to claim 1, in which the cocatalyst is an organomagnesium compound.

3. A process according to claim 1, in which the cocatalyst is an organometallic compound comprising an alkyl group bonded to the metal atom.

4. A process according to claim 1, in which the cocatalyst is a dialkylmagnesium compound or an alkylmagnesium halide.

5. A process according to claim 1, in which the metallocene is of formula (I).

6. A process according to claim 5, in which Cp¹ and Cp² are identical and are selected from the group consisting of substituted fluorenyl groups and the unsubstituted fluorenyl group of formula C₁₃H₈.

7. 9 A process according to claim 5, in which Cp¹ and Cp² each represent an unsubstituted fluorenyl group of formula C₁₃H₈.

8. A process according to claim 1, in which the symbol Y represents a group Met-G, with the symbol Met denoting a metal atom which is a rare earth metal and the symbol G denoting a group comprising the borohydride BH₄ moiety or denoting a halogen atom X selected from the group consisting of chlorine, fluorine, bromine and iodine.

9. A process according to claim 8, in which the symbol G denotes a chlorine atom or a group of formula (III)
(BH₄)_{(1+y)-}L_{y}-N_{X} (III)
in which:
L represents an alkali metal selected from the group consisting of lithium, sodium and potassium,
N represents a molecule of an ether,
x, which may or may not be an integer, is equal to or greater than 0,
y, which is an integer, is equal to or greater than 0.

10. A process according to claim 1, in which the rare earth metal is a lanthanide, the atomic number of which varies from 57 to 71.

11. A process according to claim 1, in which the rare earth metal is neodymium, Nd.

12. A process according to claim 1, in which the bridge P corresponds to the formula ZR¹ R², Z representing a silicon or carbon atom and R¹ and R², which are identical or different, each representing an alkyl group comprising from 1 to 20 carbon atoms.

13. A process according to claim 12, in which Z is Si.

14. A process according to claim 1, in which the metallocene is a (dimethylsilyl)bisfluorenylneodymium borohydride of formula (IV):
Me₂Si(Flu)₂Nd(BH₄)_{(1+y)-}THFₓ-L_{y} (IV)
Flu representing the C₁₃H₁₈ group,
L represents an alkali metal selected from the group consisting of lithium, sodium and potassium,
x, which is optionally an integer, is equal to or greater than 0,
y, which is an integer, is equal to or greater than 0.

15. A process according to claim 14, in which the preforming monomer is 1,3-butadiene or isoprene.

16. A process according to claim 15, in which the preforming monomer is a mixture of ethylene and 1,3-butadiene.

17. A process according to claim 1, in which the preforming monomer/metal of the metallocene molar ratio has a value ranging from 5 to 1000.

18. A process according to claim 1, in which the molar ratio of cocatalyst to the metal of the metallocene has a value ranging from 0.5 to 100.

19. A process according to claim 18, in which the hydrocarbon solvent is aromatic or aliphatic.

20. A process according to claim 1, in which the base is a metal alkyl, or an alkali metal amide.
